(19) United States
(12) Patent Application Publication
(10) Pub. No.: US 2007/0008970 A1
(43) Pub. Date: Jan. 11, 2007

(54) Packet data router apparatus and method

(75) Inventors: Arun C. Alex, Bartlett, IL (US); Kunnath Sudhir, Bolingbrook, IL (US); Abhishek Sharma, Streamwood, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/168,824

(22) Filed: Jun. 28, 2005

(51) Int. Cl. H04L 12/56

(52) U.S. Cl. 370/392

(57) ABSTRACT

A packet data router (300) comprises a central node (200) that is configured and arranged to provide data packet forwarding services but not data packet routing services and a plurality of physically discrete application nodes (301, 302, and 303) that are each operably coupled to the central node wherein each of the application nodes are configured and arranged to provide data packet routing services but not data packet forwarding services.

### RELATED APPLICATIONS

This application relates to the following patent applications as were filed on even date herewith (wherein the contents of such patent applications are incorporated herein by this reference):

METHOD AND APPARATUS USING MULTIPLE APPLICATION CARDS TO COMPRISE MULTIPLE LOGICAL NETWORK ENTITIES (attorney's docket number 85234); and

SYSTEM AND METHOD FOR PERFORMING A DISTRIBUTED CONFIGURATION ACROSS DEVICES (attorney's docket number 85233).

### TECHNICAL FIELD

This invention relates generally to packet data routers.

### BACKGROUND

Packet data routers are known in the art. A router is a network entity that determines the next network point to which a data packet should be forwarded towards its destination. Routers are typically connected to at least two networks and determine which way to send each data packet based, at least in part, on a current understanding of the state of the networks to which it is connected. This comprises, in general, providing both data packet routing services (i.e., processing Routing Protocols) and providing data packet forwarding services.

In general, a one-to-one physical correspondence often exists as between a given network entity and its enabling platform. For example, a router instance will typically be installed on a single packet data communication system application card (as may be installed, for example, in a chassis that provides power and necessary or useful interfaces to the application card).

When such an application card fails for whatever reason, the routing and forwarding services associated with that router instance are usually lost until that application card returns to service or a substitute application card becomes active. In the event of the former scenario the services may be lost for an indeterminate period of time. Even in the case of the latter a switchover may consume enough time so as to result in a considerable disruption to normal services. In either case the desired service remains unavailable for some period of time that constitutes an unacceptable duration to at least some system administrators and users.

In some cases it may be possible to improve upon such latency by providing more aggressive hot standby capability. Such an approach, however, often leads to a considerable increase in expense and network resource utilization to ensure the constant updating of the backup platform (or platforms).

### BRIEF DESCRIPTION OF THE DRAWINGS

The above needs are at least partially met through provision of the packet data router apparatus and method described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a flow diagram as configured in accordance with various embodiments of the invention; and

FIG. 5 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a packet data router preferably comprises a central node that is configured and arranged to provide data packet forwarding services but not data packet routing services and a plurality of physically discrete application nodes that are each operably coupled to the central node wherein each of the application nodes are configured and arranged to provide data packet routing services but not data packet forwarding services.

Pursuant to one approach the central node can comprise a Packet Switch card. In a preferred approach the central node comprise both a host processor and a network processor. So configured, the host processor serves, at least in part, to maintain one or more data packet forwarding trees and the network processor uses selective data packet forwarding tree information as is provided thereto by the host processor to manage the forwarding of data packets.

In a preferred approach, when a routing protocol needs processing, the central node selects a given one of the application cards to process the routing protocol. When the latter completes this processing, the routing protocol results are communicated back to the central node. The central node then preferably communicates that information to the other application cards to aid in facilitating information synchronicity amongst the application cards. If desired, a lock-out period can be employed to effectively ensure that only one of the application cards will provide such routing protocol processing with respect to a given need during the lock-out period.

Also as per a preferred approach, various external network interfaces as comprise a part of the application cards are formed into corresponding groups of external network interfaces and then assigned to corresponding router instances. In any event, each of these external network interfaces is preferably visible to each of the application cards as comprises the data packet router.

So configured, those skilled in the art will appreciate that the functionality as characterizes a router is distributed over a plurality of application cards and a central node. Accordingly, a failure of any given application card does not result in the automatic loss of a specific router service capability. Instead, only some capacity to provide that service becomes reduced. Though still comprising a circumstance that may warrant attention and repair, this approach tends to greatly mitigate against the kinds of (short or long term) delay and complete loss of service as tends to be associated with various prior art approaches.

Furthermore, these teachings are deployable in a relatively technically and economically acceptable manner. These teachings also make no requirement for significant provision of redundant resources.

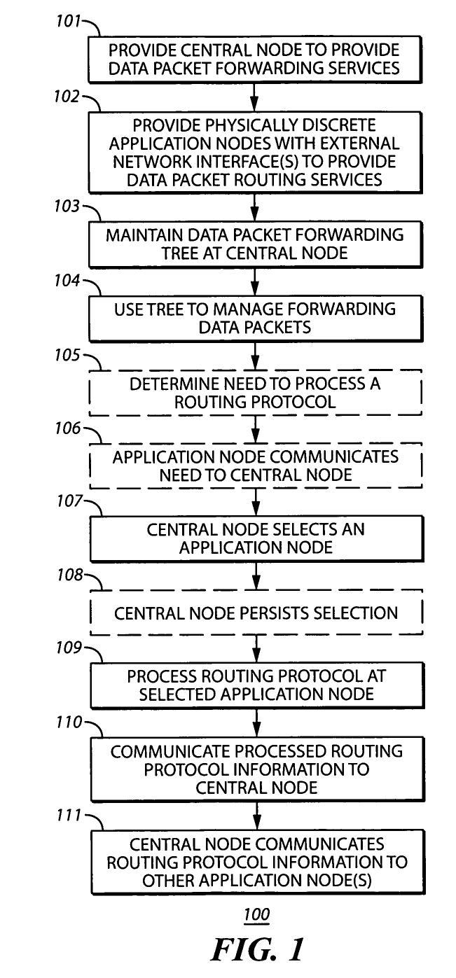

These and other benefits may become clearer upon making a thorough review and study of the following detailed description. Referring now to the drawings, and in particular to FIG. 1, a process 10 for use with a router and that accords with these teachings provides 101 a central node that is configured and arranged to provide data packet forwarding services. This central node can comprise, for example, a Packet Switch card (such as those that are available from UTStarcom) which comprises a largely programmable platform that can be readily configured and arranged to comport with the teachings set forth herein.

This process 100 also provides 102 for a plurality of physically discrete application nodes that are each operably coupled to the central node. In a preferred approach each of these application nodes is configured and arranged to provide data packet routing services and each further has at least one external network interface. These application nodes can comprise, for example, application cards such as Access GateWay cards as are available from UTStarcom and that comprise largely programmable platforms that can be readily configured and arranged as taught herein. The external network interfaces can comprise, for example, Ethernet interfaces as are well known in the art.

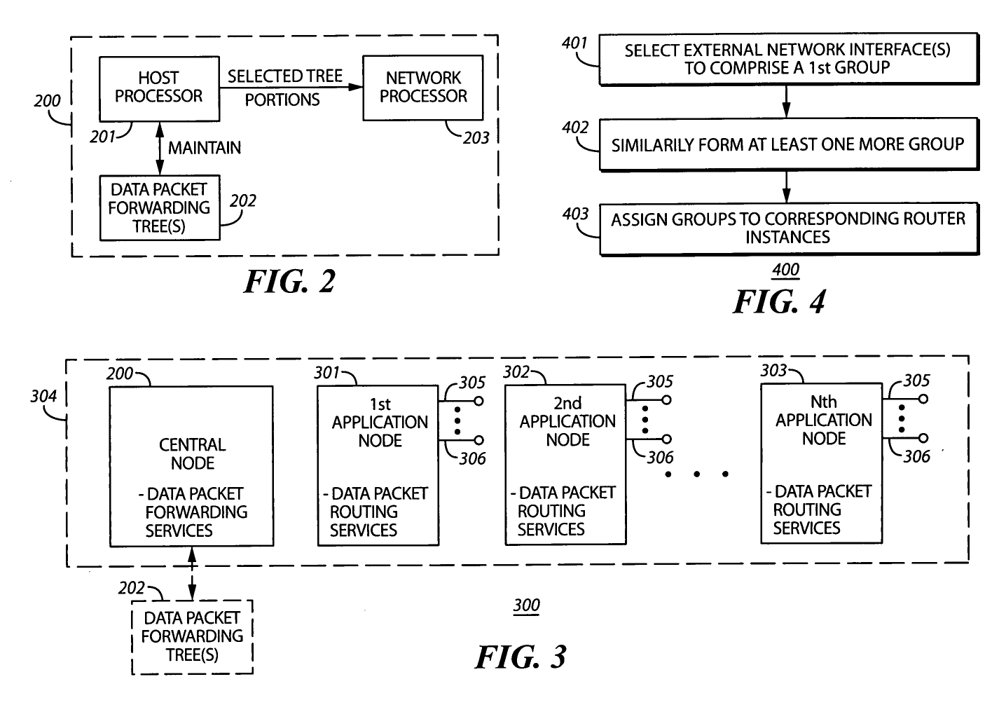

This process 100 then provides for using the central node to maintain 103 at least one (and typically more than one, as typically there will be a separate forwarding tree for each routing instance) data packet forwarding tree and for using 104 that data packet forwarding tree information to manage the forwarding of data packets via the data packet router. These steps can be accommodated in any of a wide variety of ways. In a preferred approach, and referring momentarily to FIG. 2, the central node 200 preferably comprises a host processor 201 and a separate network processor 203 (with these components being known in the art and found, for example, in a Packet Switch card as is suggested above). Using such a platform, the host processor 201 can be used to maintain the data packet forwarding trees 202 in accordance with general prior art practice in this regard while the network processor 203 uses selected portions of this data packet forwarding tree information when managing the forwarding of data packets.

Those skilled in the art will understand that such forwarding trees are used to do a gateway (or next hop) lookup before forwarding a given data packet. Each forwarding tree uses a destination address as a key, and the result is a set of candidate gateway addresses that can be used to reach that destination. In a typical approach each gateway address has a cost associated with it to reach the destination address. It is possible that one or more gateway addresses represent a same cost. In a preferred approach the host processor 201 maintains a list of all such gateways to such a destination but only updates the network processor 203 with those gateway addresses (for each such destination) that have the lowest cost. (As an ilustrative example, to reach destination x.x.x.x, the gateway addresses are y.y.y.1 (cost 1), y.y.y.2 (cost 1), z.z.z.1 (cost 2), z.z.z.2 (cost 2), and z.z.z.3 (cost 2). The host processor 201 will have the tuple {x.x.x.x, [(y.y.y.1 , y.y.y.2 ) (z.z.z.1 , z.z.z.2 , z.z.z.3)]}. The network processor 203, however, will only have the tuple {x.x.x.x, (y.y.y.1 , y.y.y.2 )} in its forwarding tree for this routing instance.)

When a data packet arrives (ingress) from an external port, the network processor 203 decides which tree to employ to effect such a lookup using, for example, port mapping and/or routing instance mapping. For a data packet that is sent from an Access GateWay card (egress) to an external network, the Access GateWay card instructs the network processor 203 to do the forwarding by doing a lookup on a specific forwarding tree.

So configured, and in a preferred embodiment, the host processor 201 therefore facilitates such functionality by forwarding some, but not all, of the data packet forwarding tree information to the network processor. Instead, the host processor 201 can select, for example, only certain preferred portions of a given data packet forwarding tree to be provided to the network processor 203. This, in turn, greatly simplifies the programming logic requirements of the network processor 203. This can be important as the network processor 203 may be expected to comprise specific hardware that serves to speed up its packet processing capability. Such an approach, often also limits the quantity of available software code space. As described, however, the programming logic can reside on a more generic processor (i.e., the host processor 201) which interfaces with large memory capacity. In the illustrative example presented above, the network processor 203 does not have to find the least cost gateways to a given destination x.x.x.x. Instead, the network processor 203 only needs to forward the packet to one of the two gateways, thereby simplifying programming logic on the network processor 203.

So configured and arranged, and referring again to FIG. 1, it will be understood that the central node serves, in part, to maintain data packet forwarding trees and to use that information to effect data packet forwarding. It will also be noted, however, that the central node does not serve to process routing protocols. In a preferred approach the application nodes provide that functionality.

In an optional but preferred step, this process 100 provides for determining 105 when a need exists to process a routing protocol. A need to process a routing protocol can arise in various ways. In some instances the need will first become evident to one (or more) of the application nodes (as versus the central node). In such a scenario, upon an application card determining 105 that a need exists to process a routing protocol (as when, for example, an external router makes such a need evident to the application card), the application node can communicate 106 that need to the central node (by transmitting, for example, a corresponding routing protocol message to the central node).

In other instances the need will first become evident to the central node itself. This can occur, for example, when the central node becomes aware of a new route being added within a given routing instance, a change in the status of a given external network interface as is attached to a given routing instance, a change in an operational status of at least one of the application nodes (for example, when an application node becomes partially or fully unavailable for whatever reason), and/or upon detecting an addition of a communication resource to a routing instance, to name but a few.

In any event, in response to such a determination (or in response to such other stimuli as a system designer or operator may wish to employ in a given setting) the central node selects 107 a given one of the application nodes to process the routing protocol. This selection can be based upon any selection criteria as may be desired. In many instances it may be helpful to simply select a first one of the application nodes as first communicates a request to process the routing protocol at issue. It may also be helpful, however, in at least some application settings to use a round robin assignment approach or some other load- leveling technique to at least attempt to maintain a relatively even distribution of routing protocol processing amongst the application cards as comprise the router.

In an optional approach, if desired, the central node persists 108 this selection for some period of time and/or until some milestone event is achieved or trigger event occurs. For example, pursuant to one approach, this selection of a particular application node to process a given routing protocol can persist pending receipt of a release message by the central node as transmitted by the selected application node. This mechanism in turn results in automatic load balancing. When the selected application node releases the table lock, any of the other application nodes can request to lock the table and thereby become the selected node. The least loaded application will most likely be the one to acquire the lock from the central node.

The selected application node then processes 109 the routing protocol (using, for example, well-understood prior art technique in this regard). Upon completing this processing, the application node then communicates 110 the resultant processed routing protocol information to the central node. The central node then communicates 111 that processed routing protocol information to at least some of the other application nodes other than the originally selected node. In a preferred approach this comprises providing the information to all of the application nodes. This action, in turn, ensures that all of the application cards are synchronized with respect to all currently available routing protocols such that each application card remains viably enabled to support additional routing protocol processing as it becomes necessary.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment a packet data router 300 comprises a central node 200 such as was described earlier and a plurality of application nodes 301, 302, and 303. These components couple to and interact with one another via a backplane 304 in accordance with well-understood prior art practice in this regard. As described above, the central node 200 provides data packet forwarding services (which includes the maintenance and use of data packet forwarding tree(s) 202) but not data packet routing services while the application nodes 301-303 provide data packet routing services but not data packet forwarding services.

To facilitate this functionality, in a preferred embodiment the central node 200 is further configured and arranged to maintain a separate data packet forwarding tree for each router instance as comprises the packet data router 300. Also, and again as a preferred but not required approach, the application nodes 301-303 are further configured and arranged to at least attempt to respond to reception of a received routing protocol data packet. In a preferred approach, however, this attempt will typically comprise contacting the central node 200 to seek a corresponding assignment in that regard. It is preferably only upon actually being assigned this task by the central node 200 that a given application card will actually respond to a given received routing protocol data packet.

In this illustrative embodiment each of the application nodes 301-303 also comprises a plurality of external network interfaces 305 and 306. In a preferred approach, each such external network interface is functionally visible to each of the application nodes. To illustrate, the external network interfaces 305 and 306 as comprise a part of the first application node 301 are known to the second through Nth application nodes 302 and 303. In such a case, and where the data packet router 300 comprises a plurality of router instances, at least one such external network interface is discretely configured to support only a corresponding one of the plurality of router instances. Accordingly, it will be appreciated that each such router instance is therefore supported by at least one of the external network interfaces.

So configured, and pursuant to a preferred approach, a data packet arriving via one of the external network interfaces as is assigned to a first router instance and that arrives at an external network interface as is assigned to a second router instance will not be directly forwarded. Instead, the data packet can be decapsulated and a new resultant data packet then transmitted from the first router instance to the second router instance.

In a preferred approach 400, and referring now to FIG. 4, at least one of the external network interfaces is selected 401 to comprise a first group of external network interfaces. Other groups are similarly formed 402 and these groups are then assigned 403 to the various router instances as comprise the data packet router. So configured, the various router instances are each supported by at least one (and typically more than one) different external network interface in a segregated fashion.

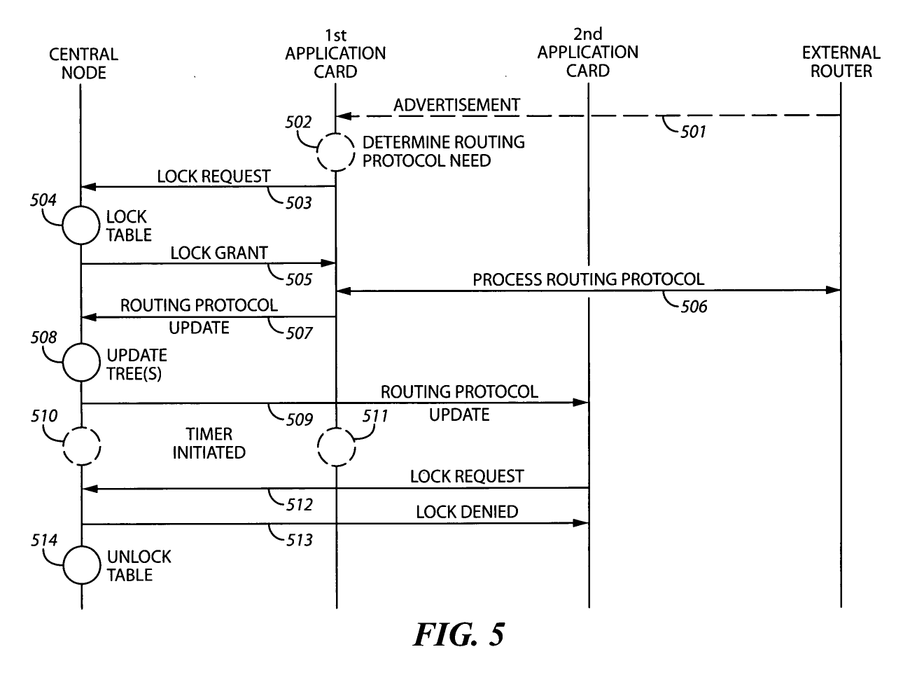

These teachings can be employed to support a variety of router services. As but one example of many, and referring now to FIG. 5, a first application card as described above may receive a router advertisement 501 from an external router (via, for example, a previously described external network interface). This, in turn, provides a basis for the first application card to determine the existence of a routing protocol need 502. The first application card, in response, transmits a lock request 503 to the central node (via, for example, the aforementioned backplane).

The central node, in response (and likely upon determining that no other application card is already processing this routing protocol), locks the table 504 and replies with a lock grant message 505 to the first application card. (It will be understand that “table” refers to a control element for the forwarding tree. The control element does not need to know the exact forwarding tree, it only needs to know that such a tree exists and that this tree is shared among the different application nodes. The control element provides the locking/unlocking mechanism to keep the forwarding tree synchronized. The central node also keeps the forwarding tree, which gets updated when the application node sends an update 507 to the control node.)The first application card, having been so selected, then processes the routing protocol 506 with the external router (using, for example, prior art techniques in this regard). Upon concluding this processing the first application card then transmits a routing protocol update message 507 to the central node.

The central node updates its previously described data packet forwarding tree(s) 508 and then transmits (which may comprise a multi-cast when available) a routing protocol update 509 to at least other of the application cards and preferably to all of the application cards to thereby permit the other application cards to synchronize their routing information to include the recent processing results of the first application card.

In a preferred, though optional, action the central node and the first application card initiate a timer 510 and 511, respectively, to govern a duration of time during which only the first application card will be permitted to effect further processing as regards this routing protocol. (Those skilled in the art will recognize that such a timer can be initiated earlier, or later, in the described process as may be desired and/or useful in a given application setting.) During this timed window, any lock requests 512 as are received by the central node from other application nodes with respect to this router protocol will be denied 513. Eventually, at the conclusion of the aforementioned timers, this window of exclusivity will expire and the central node can respond by unlocking the table 514 pending a subsequent request from any of the application nodes to again effect a corresponding routing protocol process.

So configured the ordinary and expected functionality as characterizes a data packet router is supported via a plurality of physically discrete enabling platforms. As each application node is essentially independent, however, in that any of the application nodes is capable to processing routing protocols, it will be recognized and appreciated that a loss of any of the application cards will not result in a failure of the router platform as a whole. The router platform will still be able to handle its maximum number of simultaneous routing protocols so long as one of the application nodes is up. Of course, data packets for given sessions (such as for mobile stations that are registered with a failed PDSN/HA application node) will be dropped and will not be forwarded.

It will also be seen that the capacity of such a router can be readily increased by adding more application cards to the platform. For example, since one can deploy as many external network interfaces with a given routing instance as there are corresponding ports in the corresponding assigned interface cluster, one can readily add more physical interfaces to a particular routing instance by adding another application node to the router platform.

These teachings generally ensure a relatively efficient and conservative approach to effecting the various tasks associated with a router. It may also be seen that these teachings are readily compatible with a variety of routing protocols including but not limited to Open Shortest Path First (OSPF), Routing Information Protocol (RIP), and so forth. It will also be seen that these teachings will readily permit routing protocol processing (which can comprise a computationally intensive activity) to be assigned, if desired, on a case-by-case basis to whichever application node might, at any given moment, be less burdened by current processing requirements.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A packet data router comprising:
a central node configured and arranged to provide data packet forwarding services but not data packet routing services;
a plurality of physically discrete application nodes that are each operably coupled to the central node, wherein each of the application nodes are configured and arranged to provide data packet routing services but not data packet forwarding services.

2. The packet data router of claim 1 wherein the central node comprises a Packet Switch card.

3. The packet data router of claim 1 wherein the central node is further configured and arranged to maintain at least one data packet forwarding tree.

4. The packet data router of claim 1 wherein the central node is further configured and arranged to automatically multicast received Routing Protocol data packets to each of the application nodes.

5. The packet data router of claim 1 wherein each of the application nodes comprises means for attempting to respond to each received Routing Protocol data packet.

6. The packet data router of claim 5 wherein the means for attempting to respond to each received Routing Protocol data packet further comprises means for only actually responding to a given received Routing Protocol data packet upon being assigned by the central node.

7. The packet data router of claim 1 wherein each of the application nodes further comprises at least one external network interface and wherein each such external network interface is functionally visible to each of the application nodes.

8. The packet data router of claim 7 wherein the packet data router comprises a plurality of router instances and wherein at least one of the external network interfaces is discretely configured to support only a corresponding one of the plurality of router instances, such that each of the plurality of router instances is supported by at least one of the external network interfaces.

9. The packet data router of claim 8 wherein the central node is further configured and arranged to maintain a separate data packet forwarding tree for each of the router instances.

10. A method of providing a data packet router comprising:
providing a central node configured and arranged to provide data packet forwarding services;
providing a plurality of physically discrete application nodes that are each operably coupled to the central node, wherein each of the application nodes are configured and arranged to provide data packet routing services and wherein each of the application nodes has at least one external network interface.

11. The method of claim 10 further comprising:
using the central node to maintain a data packet forwarding tree.

12. The method of claim 11 further comprising:
using the data packet forwarding tree when managing forwarding data packets via the data packet router.

13. The method of claim 12 wherein providing a central node further comprises providing a central node comprising a host processor and a network processor, and wherein:
using the central node to maintain a data packet forwarding tree comprises using the host processor to maintain the data packet forwarding tree;
using the data packet forwarding tree when managing forwarding data packets via the data packet router comprises using the network processor to use the data packet forwarding tree when managing forwarding data packets via the data packet router.

14. The method of claim 13 further comprising:
using the host processor to select preferred portions of the data packet forwarding tree;
forwarding the preferred portions of the data packet forwarding tree, but not all of the data packet forwarding tree, from the host processor to the network processor.

15. The method of claim 10 further comprising:
selecting, at the central node, a given one of the application nodes to process the routing protocol to provide a selected application node;
processing a routing protocol at the selected application node;
communicating processed routing protocol information from the selected application node to the central node;
communicating corresponding processed routing protocol information to at least some of the application nodes other than the selected application node.

16. The method of claim 15 wherein selecting, at the central node, a given one of the application nodes to process the routing protocol comprises selecting a first one of the application nodes as communicates a request to process the routing protocol.

17. The method of claim 15 further comprising:
persisting selection of the selected application node to process the routing protocol pending receipt of a release message from the selected application node.

18. The method of claim 15 wherein communicating corresponding processed routing protocol information to at least some of the application nodes other than the selected application node further comprises communicating corresponding processed routing protocol information to all of the application nodes.

19. The method of claim 15 further comprising, prior to selecting the selected application node:
determining, at at least one of the application nodes, a need to process a routing protocol;
communicating a corresponding routing protocol message to the central node.

20. The method of claim 15 wherein selecting, at the central node, a given one of the application nodes to process the routing protocol to provide a selected application node further comprises selecting the given one of the application nodes in response to at least one of:
a new route being added within a given routing instance;
a change in a status of a given external network interface as is attached to a given routing instance;
a change in an operational status of at least one of the application nodes;
an addition of a communication resource to a routing instance.

21. The method of claim 10 further comprising:
selecting at least one of the external network interfaces to comprise a first group of external network interfaces;
selecting at least another one of the external network interfaces to comprise a second group of external network interfaces;
assigning the first group of external network interfaces to a first router instance;
assigning the second group of external network interfaces to a second router instance.

22. The method of claim 21 further comprising:
not forwarding a data packet arriving via an external network interface as is assigned to the first router instance as arrives at an external network interface as is assigned to the second router instance.

23. A packet data router apparatus comprising:
first means for providing data packet forwarding services but not data packet routing services;
a plurality of physically discrete second means that are each operably coupled to the first means for providing data packet routing services but not data packet forwarding services.

24. The packet data router apparatus of claim 23 wherein the first means is further for maintaining at least one data packet forwarding tree.

25. The packet data router apparatus of claim 24 wherein each of the plurality of physically discrete second means further comprises external network interface means, wherein at least some of the external network interface means are each assigned in a segregated fashion to different corresponding router instances.

26. The packet data router apparatus of claim 23 wherein each of the second means further comprises means for at least attempting to process routing protocol information in conjunction with an external information source.

27. The packet data router apparatus of claim 26 wherein each of the second means further comprises means for requesting that the first means assign a requesting second means to process a given routing protocol.
